(19) United States
(12) Patent Application Publication
(10) Pub. No.: US 2005/0152151 A1
(43) Pub. Date: Jul. 14, 2005

(54) Adverse weather automatic sign light shield

(75) Inventors: Michael F. Lisowski, Anderson, IN (US); Tony E. Collins, Alexandria, IN (US)

Correspondence Address: ICE MILLER, ONE AMERICAN SQUARE, BOX 82001, INDIANAPOLIS, IN, 46282, US

(73) Assignee: Guide Corporation, Pendleton, IN (US)

(21) Appl. No.: 10/757,698

(22) Filed: Jan. 14, 2004

(51) Int. Cl. F21V 17/02

(52) U.S. Cl. 362/513

(57) ABSTRACT

The subject invention relates to automotive headlamp assemblies with a sign light shield. In an exemplary embodiment, the sign light shield can be raised or lowered by an actuator into or out of a reflecting position that allows the sign light shield to reflect light emitted from a light source through the upper portion of a lens. In another embodiment, the headlamp assembly can comprise two cutoff shields mounted to a rotatable shaft, where one of the cutoff shields has a sign light shield mounted directly to it and the other cutoff shield does not have a sign light shield. An actuator rotates the shaft until the sign light shield is in a position that will allow it to reflect light out of the upper portion of the lens or until the sign light shield is in a position where it cannot reflect any light.

### BACKGROUND OF THE INVENTION

Developers and designers continue to improve upon the design and structure of automotive lighting systems in order to increase driver visibility. FIG. 1 shows a front view of a typical projector headlamp assembly 20. As shown in FIG. 1, a typical projector headlamp assembly 20 has a lamp housing 28 that contains a light source 22 surrounded by a reflector 24. Light source 22 and reflector 24 are covered by a lens 26 that is attached to lamp housing 28. Headlamp assembly 20 further comprises a cutoff shield 30 mounted on a shaft 32. Cutoff shield 30 and shaft 32 can be rotated in order to place the cutoff shield into a blocking position (as shown in FIG. 1) or a pass-through position. When cutoff shield 30 is in the blocking position, it prevents some of the light emitted from light source 22 from reaching the upper half of lens 26 in order to reduce the amount of glare perceived by oncoming drivers (the low beam setting/low beam light pattern). When cutoff shield 30 is in the pass-through position, it allows light to reach the upper half of lens 26 and allows for great illumination of the road and the driver's surroundings (high beam setting/high beam light pattern). When the headlamp assembly is in its high beam setting, there is typically plenty of illumination to allow the driver to see the road and road signs clearly. However, when cutoff shield 30 is in the blocking position, the headlamp assembly does not emit as much light and it becomes difficult for the driver to see road signs. In order to address this problem, designers have added a stationary sign light shield to the headlamp assembly 20.

FIG. 2 shows an exploded view of headlamp assembly 20. As can be seen in FIG. 2, a stationary sign light shield 34 is mounted to cutoff shield 30 and forms a lip on top of the cutoff shield that extends outward from the cutoff shield in a direction toward lens 26. Stationary sign light shield 34 includes a reflective surface that directs light toward the top portion of lens 26. In operation, light source 22 emits light towards lens 26. Cutoff shield 30 prevents some of the light from passing through the upper half of lens 26 (particularly light that creates glare) and stationary sign light shield 34 reflects any light that strikes its top surface upward through the lens. Thus, headlamp assembly 20 with sign light shield 34 is able to illuminate signs above or to the side of the road when the driver is using the low beam setting without blinding oncoming drivers.

While this headlamp assembly provides greater illumination of an automobile's surroundings, stationary sign light shield 34 provides some disadvantages as well. Stationary sign light shields have the disadvantage of causing glare problems during adverse weather conditions. Specifically, during foggy and snowy conditions, the light reflected upward by sign light shield 34 reflects off of the water particles in the air and creates a “veil” of light that reflects back at the driver. As used herein, the term “veil” refers to a large amount of glare that is reflected off of water particles in the air during foggy and snowy conditions. Such a veil inhibits the driver's ability to see the road and increases the possibilities of accidents due to visibility problems.

Accordingly, it is desirable to have an automotive forward lamp assembly that allows a driver to use a sign light shield during clear and rainy conditions but allows the driver to discontinue use of the sign light shield whenever it produces a veil. Specifically, it is desirable to develop a sign light shield that can be moved into a reflecting position during clear and rainy conditions and lowered out of position during foggy and snowy conditions.

### BRIEF SUMMARY OF THE INVENTION

The subject invention relates to automotive headlamp assemblies that utilize sign light shields. Specifically, an adverse weather automatic sign light shield that can be moved in between a reflecting position, where the sign light shield reflects light emitted from a light source through the upper portion of a lens, and a non-reflecting position or reduced reflecting position, where either the sign light shield does not reflect any of the emitted light from the light source out of the lens or reflects an insignificant amount of light out of the lens (i.e. an amount of light that does not cause glare). In one embodiment, the sign light shield is positioned in between a cutoff shield and a lens and operably connected to an actuator, such as a solenoid or a stepper motor, that can raise the sign light shield into its reflecting position. Further, in this embodiment, the actuator can lower the sign light shield when it creates a veil (i.e., when the sign light shield is used during snowy or foggy weather conditions). The sign light shield and actuator can be operably connected to a switch located in the vehicle's passenger compartment or can be connected to computerized controllers and sensor relays that automatically control whether the actuator raises or lowers the sign light shield.

In another embodiment, the sign light shield is mounted directly to a cutoff shield and the cutoff shield is mounted to a rotatable shaft. A second cutoff shield that does not have a sign light shield is also mounted to the rotatable shaft. In this embodiment, the automotive front lamp assembly has three settings. The first setting positions the cutoff shield with the sign light shield in a blocking position so that the sign light shield can reflect light emitted from the light source through the upper portion of the lens. As used herein, the term “blocking position” refers to the position where the cutoff shield prevents some light emitted from the light source from reaching the upper portion of the lens in order to form a low beam light pattern. In the first setting, the second cutoff shield occupies a pass-through position. As used herein, the term “pass-through position” refers to a position where the cutoff shield does not block the light emitted from the light source in order to form a high beam light pattern.

The second setting positions the second cutoff shield in a blocking position while the cutoff shield with the sign light shield occupies a pass-through position. The sign light shield will not reflect any of the emitted light from the light source in this position. The third setting positions the cutoff shield with the sign light shield and the second cutoff shield in pass-through positions so that the automotive front lamp assembly can emit a high beam light pattern. In this embodiment, an actuator is connected to the rotatable shaft so that it can rotate the cutoff shields in between the automotive front lamp assembly's first, second and third settings.

### BRIEF DESCRIPTION OF THE DRAWINGS

FIG. 1 shows a front view of a typical projector headlamp assembly;

FIG. 2 shows an exploded view of the typical projector headlamp assembly;

FIG. 3a shows a top view of an exemplary embodiment of the subject invention without the lamp housing;

FIG. 3b shows an isolated view of cutoff shield in its pass-through position;

FIG. 3c shows an isolated view of cutoff shield in its blocking position;

FIG. 4 shows a cross-sectional side view of the exemplary embodiment along line A-A of FIG. 3a;

FIG. 5 shows a top view of another exemplary embodiment of the subject invention without the lamp housing;

FIG. 6 shows a cross-sectional side view of the exemplary embodiment of FIG. 5 in its first low beam, setting along line B-B of FIG. 5;

FIG. 7 shows a cross-sectional side view of the exemplary embodiment of FIG. 5 in its second low beam setting along line B-B of FIG. 5; and

FIG. 8 shows a cross-sectional side view of the exemplary embodiment of FIG. 5 in its high beam setting along line B-B of FIG. 5.

### DETAILED OF THE INVENTION

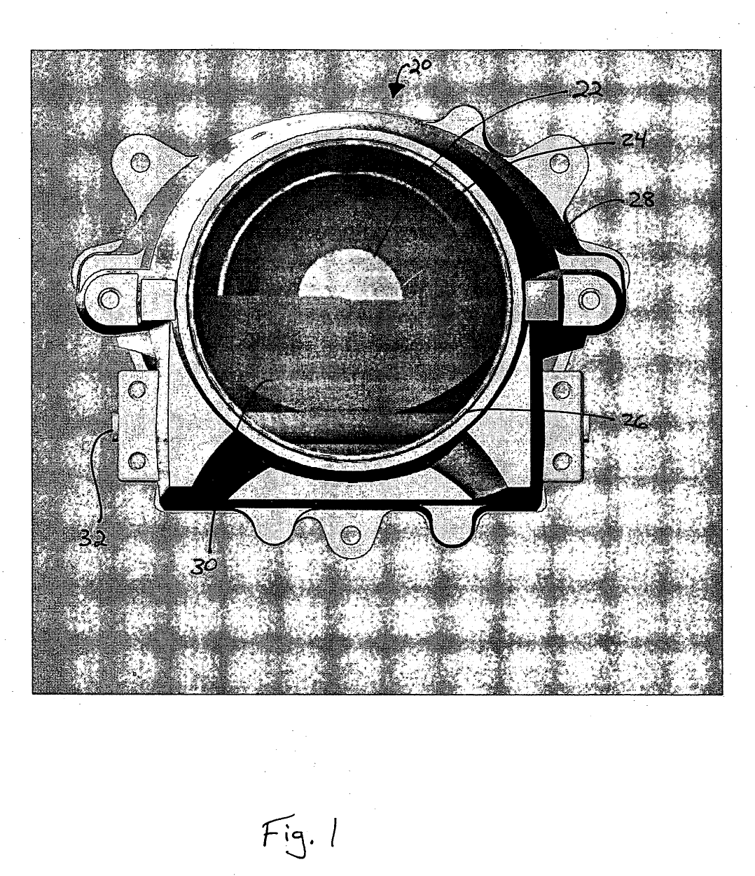

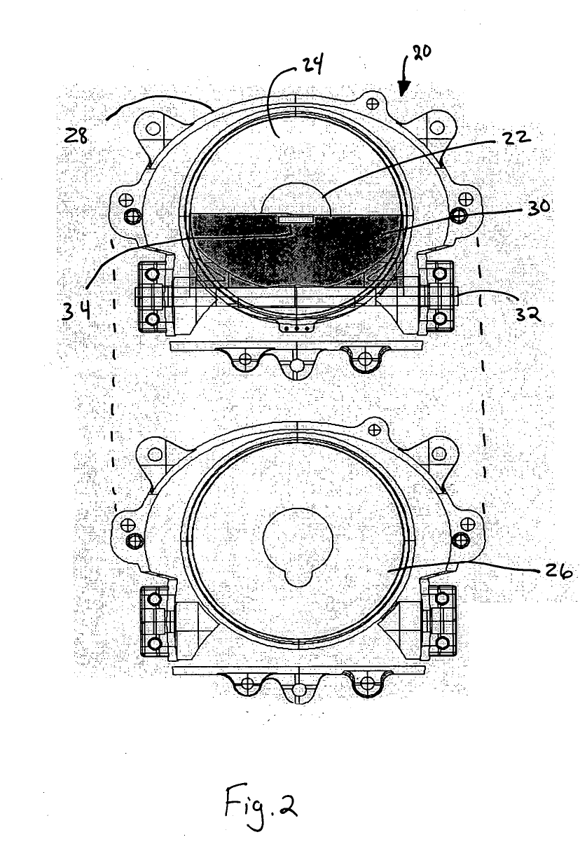

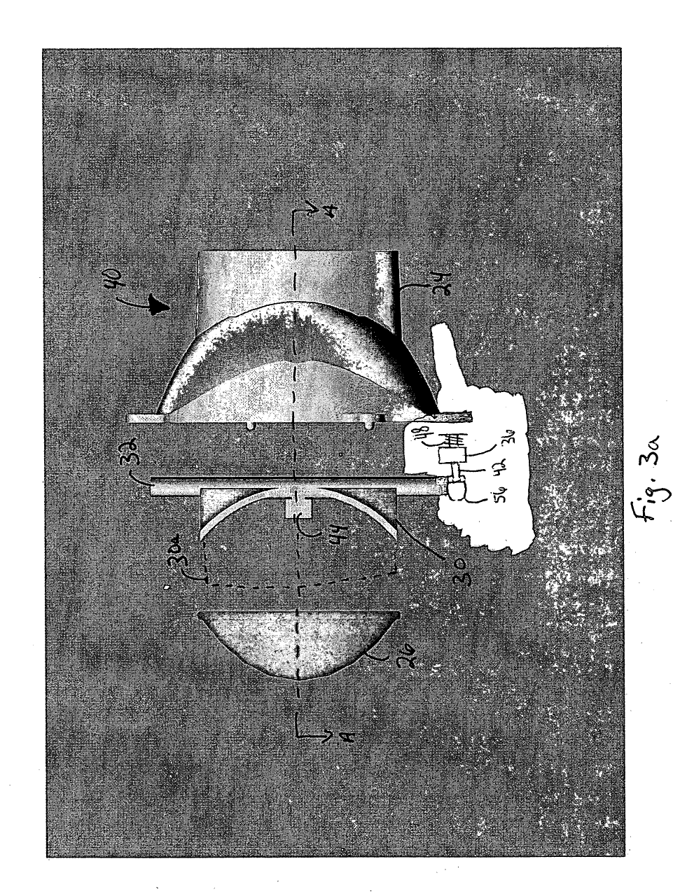

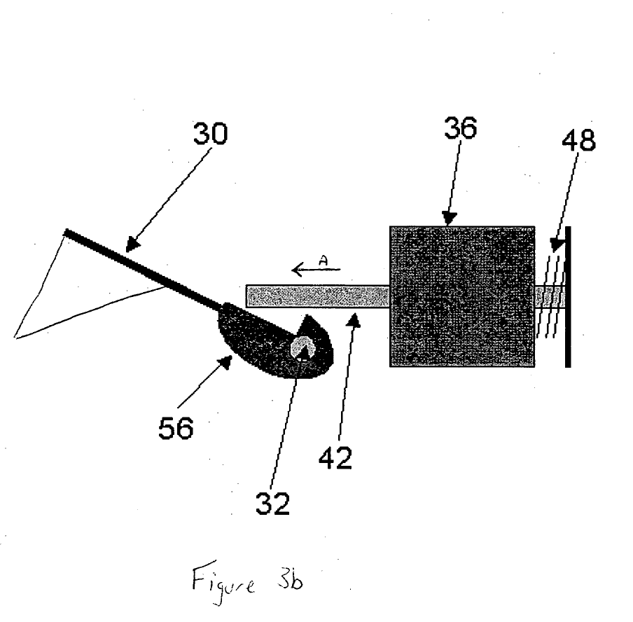

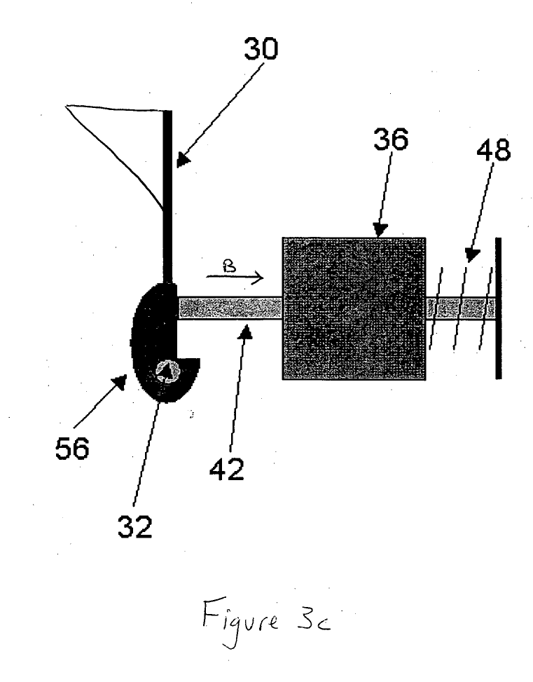

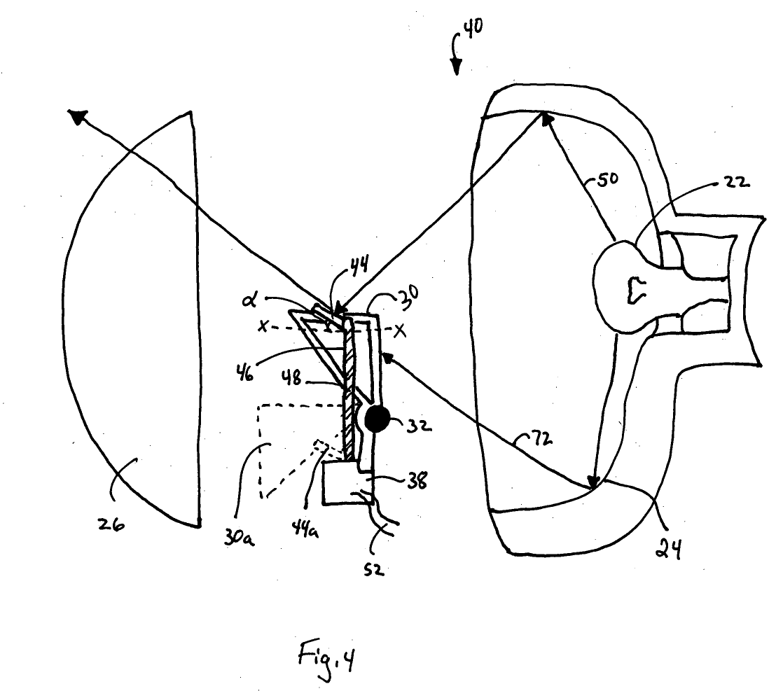

It will be appreciated by one skilled in the art that the embodiments of the subject invention described herein have basically the same external appearance as FIG. 1. Accordingly, many of the same reference numbers are used in FIGS. 3-8 as were used in FIGS. 1-2. FIG. 3a shows a top view of an exemplary embodiment of a lamp assembly having an adverse weather automatic sign light shield without lamp housing 28. As can be seen in FIG. 3a, this exemplary embodiment comprises a high beam/low beam projector headlamp assembly 40. Similar to the already described typical projector headlamp assembly, headlamp assembly 40 comprises reflector 24, light source 22 (shown in FIG. 4) and lens 26. Headlamp assembly 40 also has cutoff shield 30 positioned in between the lens and the reflector. As shown in FIG. 3a, cutoff shield 30 is a cylindrical portion that forms a C-shape where the open part of the C-shape faces lens 26. Cutoff shield 30 is mounted to shaft 32. Shaft 32 has one end connected to a cam 56. Cam 56 interacts with an actuator, such as a solenoid 36. Solenoid 36 has a plunger 42 that interacts with cam 56. Wire 54 connects solenoid 36 to a power source (not pictured). The power source is connected to a controlling mechanism, such as a switch, that allows the driver to turn the power source on and off in order to switch between the low beam and high beam settings.

FIG. 3b is an isolated view of cutoff shield 30 in its pass-through position with solenoid 36. Referring to both FIGS. 3a and 3b, cutoff shield 30 can be rotated into a blocking position or into a pass-through position (shown by dotted line 30a in FIGS. 3a and 4). As shown in FIGS. 3b and 3c, solenoid 36 causes cutoff shield 30 to rotate between its pass-through and blocking positions. As shown in FIG. 3b, solenoid 36 withdraws a plunger 42 away from condensing 26 (as shown by line A) when it receives a charge from the power source through wire 54. When solenoid 36 receives a charge, it creates a magnetic field that causes plunger 42 to retract into the solenoid which in turn causes cam 56 to rotate. As cam 56 rotates, it interacts with shaft 32 and causes the shaft and cutoff shield 30 to rotate counter-clockwise so that the cutoff shield 30 is rotated towards condensing lens 26 and lowered into its pass-through position (i.e. the high beam setting). As plunger 42 withdraws into solenoid 36, a spring 48 located around the plunger contracts. While solenoid 36 receives a charge, the magnetic field created by the solenoid is stronger than the tension in spring 48 and plunger 42 is held in place.

FIG. 3c shows an isolated view of cutoff shield 30 in its blocking position. As shown in FIG. 3c, when the power source is turned off, the magnetic field will no longer exist and spring 48 will expand and cause plunger 42 to move rearward away from cam 56 in the direction of line B. This causes cutoff shield 30 to rotate into its blocking position. As plunger 42 moves away from cam 56, cam 56 and shaft 32 rotate clockwise so that the cutoff shield 30 rotates away from condensing lens 26 and is raised into its blocking position (i.e. the low beam setting). A torsion spring (not pictured) is positioned around shaft 32 to assist in the movement of cutoff shield 30 in between its blocking and pass-through positions. The positions and combination of solenoid 36, plunger 42, cam 56, spring 48, shaft 32 and the torsion spring around the shaft ensures that the low beam will be projected from the headlamp if the solenoid failed. As already mentioned, a controlling mechanism allows the driver to control when the cutoff shield is rotated into its pass-through or blocking position. In this manner, headlamp assembly 40 can be switched between its high beam and low beam settings.

As shown in FIG. 3a, projector headlamp assembly 40 further comprises a movable sign light shield 44. Sign light shield 44 is located in between cutoff shield 30 and lens 26. FIG. 4 shows a cross-sectional view of projector headlamp assembly 40 along line A-A of FIG. 3a. As shown in FIG. 4, a solenoid's extension 46 connects sign light shield 44 to a solenoid 38. A wire 52 connects solenoid 38 to a power source (not shown) that provides a charge to the solenoid. When the power source charges solenoid 38, the solenoid 38 creates a magnetic field that causes extension 46 to withdraw. By withdrawing extension 46, solenoid 38 lowers sign light shield 44 out of position so that it does not reflect any (or reflects an insignificant amount) of the emitted light from light source 22 (a nonreflecting position and/or a reduced reflecting position). When the power supply is shut off, the magnetic field ceases to exist and spring 48 causes sign light shield 44 and extension 46 to extend into a position where the sign light shield can reflect light through the top portion of lens 26 (a reflecting position). The power source that controls solenoid 38 is connected to a controlling mechanism, such as a switch, so that the driver can turn the power source on and off. In this manner, the driver can prevent a veil from forming by using the controlling mechanism to lower the sign light shield out of its reflecting position during foggy and snowy conditions and can improve his and/or her visibility by raising the sign light shield during clear and rainy conditions.

FIG. 4 shows sign light shield 44 in its reflecting position and cutoff shield 30 in its blocking position. As shown by a light ray 72 in FIG. 4, some of the emitted light will be blocked by cutoff shield 30 so that it will not pass through the upper portion of lens 26. As shown by a light ray 50, some of the emitted light from light source 22 will strike the top of sign light shield 44 and be reflected out of the top portion of lens 26 at an angle that will not cause glare to oncoming drivers. This will provide more light in the low beam setting for the driver to see road signs. When sign light shield 44 is lowered out of its reflecting position (shown by dotted line 44a), none (or an insignificant amount) of the emitted light will be reflected out of the top portion of lens 26 by sign light shield 44.

Solenoid 38 and its power source are also connected to the controlling mechanism that operates solenoid 36. Thus, when a driver uses the controlling mechanism to cause headlamp assembly 40 to switch to the high beam setting, the driver will also cause sign light shield 44 to lower into its nonreflecting position (shown by dotted line 44a). Solenoid 38 lowers sign light shield 44 far enough to allow cutoff shield 30 to rotate into its pass-through position. It will be appreciated by one skilled in the art that sign light shield 44 lowers into the nonreflecting position prior to shaft 32 rotating cutoff shield 30. In the high beam setting, the light emitted by light source 22 reflects off reflector 24 and emits out of lens 26 without being blocked or obstructed by sign light shield 44 and/or cutoff shield 30.

It will be appreciated by one skilled in the art that the controlling mechanism for solenoids 38 and 36 do not have to comprise a switch, but can comprise any number of controlling mechanisms known in the art. For example, solenoid 38 can be controlled with a microprocessor that uses sensors to determine when sign light shield 44 should be raised into or lowered out of its reflecting position. It will be appreciated by one skilled in the art that the subject invention is not limited to the use of a solenoid to raise and lower sign light shield and cutoff shield into and out of position. One skilled in the art will realize that any other type of actuator (e.g. a stepper motor or lever arm) can be utilized to raise and lower the sign light shield and cutoff shield.

Sign light shield 44 is a reflective surface that can be formed by any reflective material that can withstand the high operating temperatures of a projector headlamp assembly. For example, the sign light shield can be manufactured from die cast aluminum and coated with a reflective aluminum coating by an aluminization process. The sign light shield is connected to extension 46 by means well known in the art. For example, the sign light shield can be connected by a screw, a bolt or a cotter pin. As shown in FIG. 4, sign light shield 44 is connected to extension 46 at an angle a relative to the horizontal/optical axis x-x. Angle a usually is between 0 and 15 degrees. However, for optimal results, sign light shield 44 should be tilted between 5 and 7 degrees. While FIGS. 3 and 4 show that the sign light shield is rectangular in shape and angled slightly, it will be appreciated by one skilled in the art that the sign light shield can be any shape, curve or angle in order to reflect the required amount of light out the top portion of the lens in a desired direction.

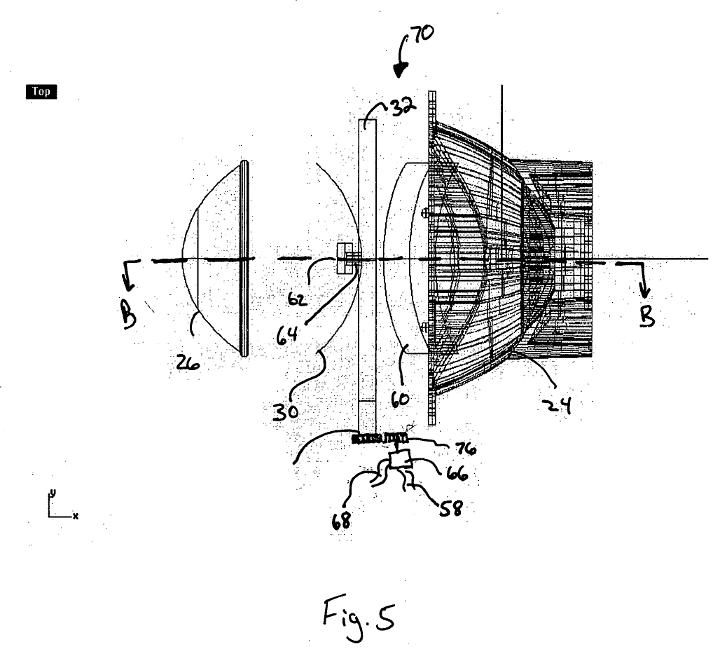

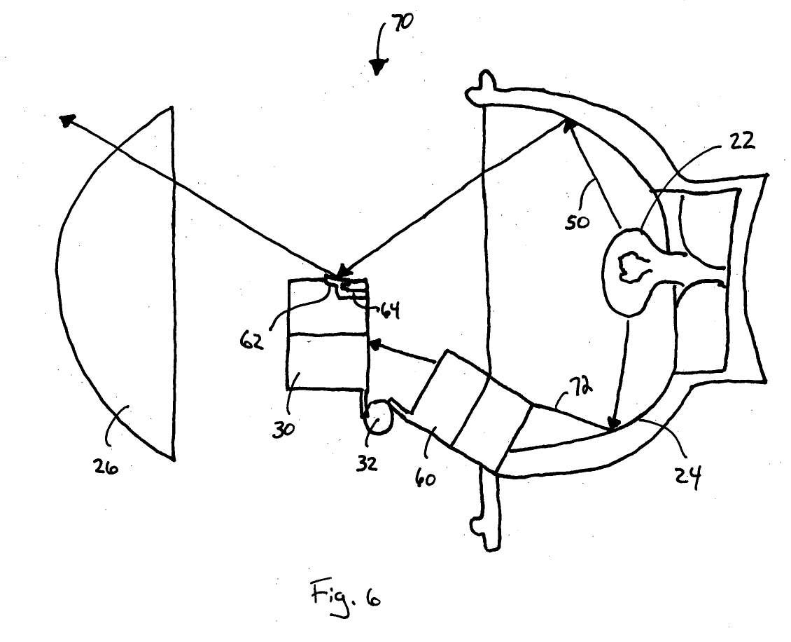

FIG. 5 shows a top view of another embodiment of the subject invention without the lamp housing. As shown in FIG. 5, the embodiment comprises front headlamp assembly 70. As described in the previous embodiment, headlamp assembly 70 comprises reflector 24, lens 26 and light source 22 (shown in FIGS. 6-8). Headlamp assembly 70 also comprises cutoff shield 30 mounted to shaft 32 and an arm 64 that mounts a sign light shield 62 to the side of cutoff shield 30 facing lens 26. Arm 64 is mounted to the cutoff shield 30 and sign light shield 62 by means well known to those skilled in the art. For example, arm 64 can be bolted or screwed to both the cutoff shield 30 and sign light shield 62.

A second cutoff shield 60 is also mounted to shaft 32. Both cutoff shields 30 and 60 are mounted to shaft 32 by means well known in the art. Shaft 32 interacts with a stepper motor 66 which is connected to a power source by a wire 58. Stepper motor 66 has a gear 76 that interacts with gear 74 located on the end of shaft 32. When power is supplied to stepper motor 66, the stepper motor rotates shaft 32 clockwise or counter clockwise in order to switch in between three different settings of headlamp assembly 70. Stepper motor 66 and its power source are connected to a controlling mechanism that allows the driver to cause the headlamp assembly 70 to switch between its three different settings.

FIG. 6 shows a cross-sectional view of headlamp assembly 70 along line B-B of FIG. 5. As shown in FIG. 6, cutoff shield 30 is in a blocking position, sign light shield 62 is in a reflecting position, and cutoff shield 60 is in a pass-through position. In this setting, headlamp assembly will emit a low beam pattern because cutoff shield 30 will block some of the light emitted from light source 22 from reaching the upper portion of lens 26 (as shown by light ray 72). Further, as shown by light ray 50, some light emitted from light source 22 will reflect off of sign light shield 62 and be directed out of the top portion of lens 26 in order to provide more light for the driver. This light directed out of the top portion of the lens will help illuminate road signs either above or to the side of the driver's automobile. If this low beam setting with the sign light shield creates glare (i.e. when the sign light shield is used in snowy or foggy driving conditions), then the driver can use the controlling mechanism to cause headlamp assembly 70 to switch to its second low beam setting. Stepper motor 66 will rotate shaft 32 counter clockwise so that cutoff shield 30 and cutoff shield 60 will rotate towards lens 26. Stepper motor 66 will rotate shaft 32 until cutoff shield 30 reaches its pass-through position and cutoff shield 60 reaches its blocking position.

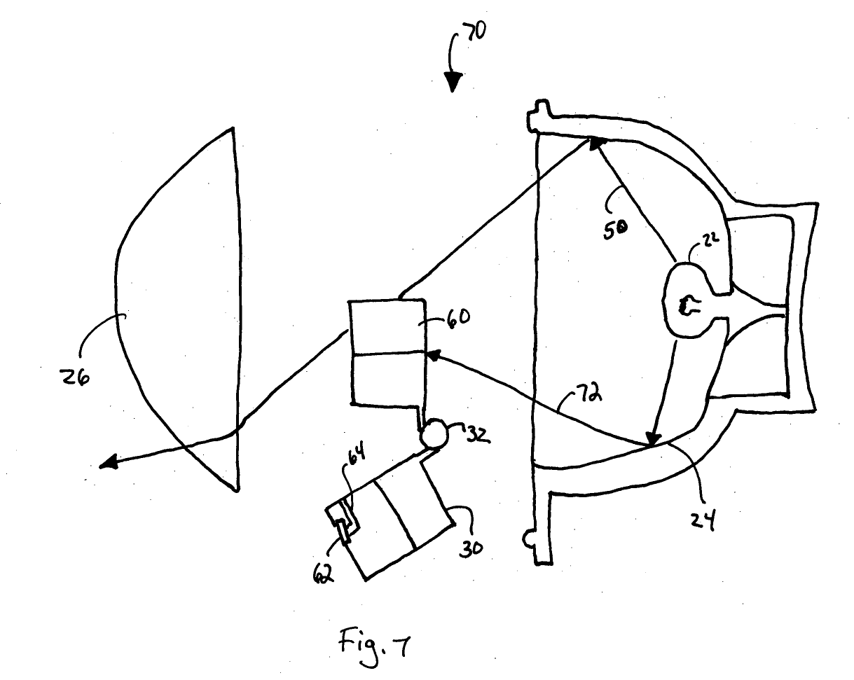

FIG. 7 shows a cross-sectional view along line B-B of FIG. 5 of headlamp assembly 70 in its second low beam setting. As shown in FIG. 7, cutoff shield 60 is in a blocking position and prevents some of the light emitted from light source 22 from reaching the upper portion of lens 26 (shown by light ray 72). Further, as shown by light ray 50, light that is normally reflected by sign light shield 62 will pass directly out of lens 26 in this low beam setting.

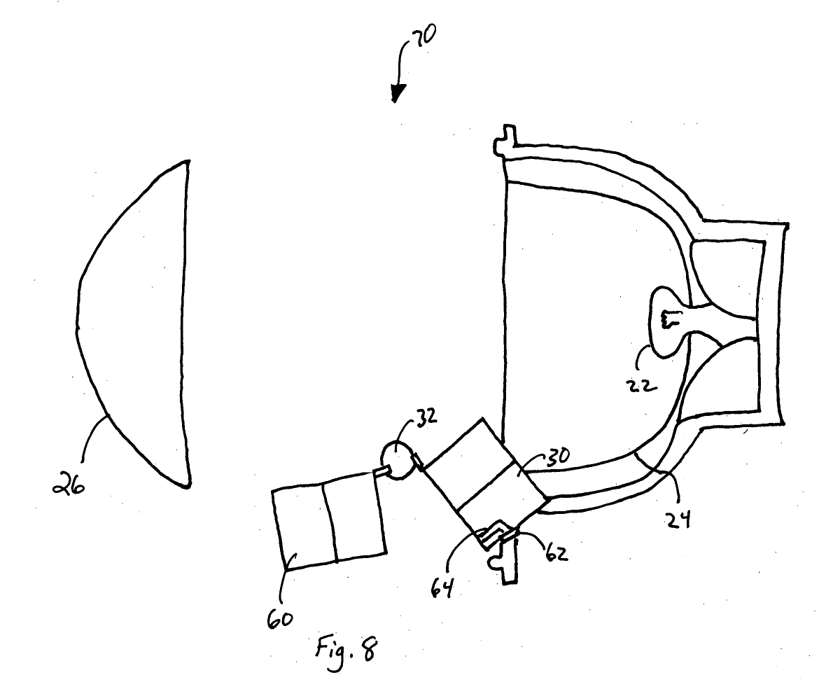

Stepper motor 66 can be connected to a second operating mechanism (not shown) by wire 68 (shown in FIG. 5). A driver can use this operating mechanism to cause headlamp assembly 70 to switch to its high beam setting. Depending on whether headlamp assembly 70 is in its first low beam setting or second low beam setting, stepper motor will either rotate shaft 32 counter clockwise or clockwise to cause both sign light shields 30 and 60 to occupy a pass-through position. FIG. 8 shows a cross-sectional view along line B-B of FIG. 5 of headlamp assembly 70 in its high beam setting. As shown in FIG. 8, sign light shields 30 and 60 are located in a pass through position so all the light emitted by light source 22 can reach and pass through lens 26 without being blocked by cutoff shields 60 and 30. In this setting, headlamp assembly 70 will emit a high beam light pattern.

While the subject invention has been described in considerable detail with references to particular embodiments thereof, such is offered by way of non-limiting examples of the invention as many other versions are possible. For example, the sign light shield could be connected directly to the cutoff shield by a hinge so that an actuator, such as a stepper motor or solenoid, can raise or lower the sign light shield by causing the sign light shield to swivel about the pivot point of the hinge. This actuator and sign light shield would rotate with the cutoff shield when the headlamp assembly switched in between its high and low beam settings. Further, while the exemplary embodiments are described in association with a high beam/low beam projector headlamp assembly, it will be appreciated by one skilled in the art that the subject invention can be utilized with just a low beam headlamp assembly unit. Further, one skilled in the art will realize that the subject invention is not limited to projector headlamp assemblies, but can be utilized in any type of headlamp assembly. It is anticipated that a variety of other modifications and changes will be apparent to those having ordinary skill in the art and that such modifications and changes are intended to be encompassed within the spirit and scope of the pending claims.

1. An automotive headlamp assembly comprising:
a. at least one reflector;
b. at least one light source positioned within the at least one reflector; and
c. at least one sign light shield positioned and located in front of the at least one light source, wherein the sign light shield is moveable between a first position, wherein the sign light shield reflects light through the at least one lens's upper portion, and a second position, wherein the sign light shield reflects an insignificant amount of light through the lens.

2. The automotive headlamp assembly of claim 1 wherein the second position places the sign light shield in a location where it does not reflect any light through the lens.

3. The automotive headlamp assembly of claim 1 further comprising at least one lens positioned and located in front of the at least one light source and the at least one reflector.

4. The automotive headlamp assembly of claim 1, wherein the at least one sign light shield is operably connected to a solenoid that moves the sign light shield between the first position and the second position.

5. The automotive headlamp assembly of claim 4, further comprising an operating mechanism operably connected to the solenoid that causes the solenoid to move the sign light shield between the first position and second position.

6. The automotive headlamp assembly of claim 1, wherein the at least one sign light shield is operably connected to a stepper motor that moves the sign light shield between the first position and the second position.

7. The automotive headlamp assembly of claim 6, further comprising an operating mechanism operably connected to the stepper motor that causes the stepper motor to move the sign light shield between the first position and second position.

8. The automotive headlamp assembly of claim 3, further comprising at least one cutoff shield located and positioned in between the at least one light source and the at least one lens.

9. The automatic headlamp assembly of claim 8, wherein the at least one sign light shield is positioned and located between the at least one cutoff shield and the at least one lens.

10. The automotive headlamp assembly of claim 8, wherein the at least one sign light shield is mounted to the at least one cutoff shield by a hinge that allows the sign light shield to move between the first position and the second position.

11. The automotive headlamp assembly of claim 8, further comprising a rotatable shaft mounted to the cutoff shield, wherein the rotatable shaft can move the cutoff shield between a blocking position to create a low beam light pattern and a pass-through position to create a high beam light pattern.

12. The automotive headlamp assembly of claim 1, wherein the at least one sign light shield is positioned at an angle from a horizontal axis of between approximately 0-15 degrees.

13. The automotive headlamp assembly of claim 1, wherein the at least one sign light shield is positioned at an angle from a horizontal axis of between approximately 5-7 degrees.

14. The automotive headlamp assembly of claim 1, wherein the at least one sign light shield comprises die cast aluminum with an aluminum coating.

15. An automotive headlamp assembly comprising:
a. at least one light source positioned within at least one reflector;
b. at least one lens positioned and located in front of the at least one light source and the at least one reflector;
c. a first cutoff shield located between the at least one lens and the at least one light source;
d. at least one sign light shield mounted to the first cutoff shield in a position and location that allows the sign light shield to reflect light through the at least one lens's upper portion when the first cutoff shield is in a blocking position; and
e. a second cutoff shield located between the at least one lens and the at least one light source.

16. The automotive headlamp assembly of claim 15, wherein the automotive headlamp assembly has a first setting, wherein the first cutoff shield is moved into a blocking position so that the sign light shield can reflect light emitted from the light source while the second cutoff shield occupies a pass-through position, a second setting, wherein the second cutoff shield is moved into a blocking position while the first cutoff shield occupies a pass-through position, and a third setting, wherein the first cutoff shield and second cutoff shield can be moved into a pass-through position.

17. The automotive headlamp assembly claim 16, further comprising a rotatable shaft mounted to both the first cutoff shield and the second cutoff shield, wherein the rotatable shaft can rotate the first cutoff shield and the second cutoff shield in between the automotive headlamp assembly's first, second and third settings.

18. The automotive headlamp assembly of claim 17, further comprising an actuator operably connected to the rotatable shaft that causes the rotatable shaft to rotate.

19. The automotive headlamp assembly of claim 18, wherein the actuator comprises a stepper motor.

20. The automotive headlamp assembly of claim 18, wherein the actuator comprises a solenoid.

21. The automotive headlamp assembly of claim 15, wherein the at least one sign light shield is mounted to the first cutoff shield at an angle from a horizontal axis of approximately 0-15 degrees.

22. The automotive headlamp assembly of claim 15, wherein the at least one sign light shield is mounted to the first cutoff shield at an angle from a horizontal axis of approximately 5-7 degrees.

23. The automotive headlamp assembly of claim 18, further comprising at least one operating mechanism operably connected to the actuator that causes the actuator to rotate the rotatable shaft and the first and second cutoff shields between the automotive front lamp assembly's first, second and third settings.

24. A method for providing greater illumination from a headlamp assembly in its low beam setting while preventing glare, comprising the steps of:
a. providing a headlamp assembly having
(i) at least one light source positioned within at least one reflector,
(ii) at least one lens positioned and located in front of the at least one light source and at least one reflector,
(iii) at least one cutoff shield positioned in between the at least one light source and at least one lens, and
(iv) at least one sign light shield;
b. moving the at least one sign light shield into a first position where the sign light reflects light emitted from the light source through the at least one lens's upper position; and
c. when glare occurs, moving the at least one sign light shield into a second position wherein the sign light shield reflects an insignificant amount of light emitted from the at least one light source.

25. The method of claim 24, wherein the at least one sign light shield is moved to a second position wherein the sign light shield does not reflect any light emitted from the at least one light source.

26. A headlamp assembly comprising:
a. at least one light source positioned within a reflector;
b. at least one lens positioned and located in front of the at least one light source and the at least one reflector;
c. at least one cutoff shield positioned and located in between the at least one lens and the at least one light source;
d. at least one sign light shield positioned and located in between the cutoff shield and the lens; and
e. a means for moving the at least one sign light shield in between a first position, wherein the sign light shield reflects light emitted from the at least one light source through the at least one lens's upper portion, and a second position, wherein the sign light shield does not reflect any light through the at least one lens.
